(19) United States
(12) Patent Application Publication
(10) Pub. No.: US 2002/0190867 A1
(43) Pub. Date: Dec. 19, 2002

(54) Transport system for long-term transport and transport container, preferably for long- term transport

(76) Inventors: Werner Sommer, Berlin (DE); Eberhard Lampeter, Leipzig (DE)

Correspondence Address: Lerner and Greenberg, P O Box 2480, Hollywood, FL, 33020-2480, US

(21) Appl. No.: 10/149,474

(22) PCT Filed: Oct. 5, 2001
(86) PCT No.: PCT/DE01/03854

(30) Foreign Application Priority Data
Oct. 6, 2000 (DE) 100 49 984.8

(51) Int. Cl. G08B 21/00

(52) U.S. Cl. 340/674; 340/586; 340/693.5

(57) ABSTRACT

Transport system for the long-term transport of preferably biological material and transport container, preferably for this transport system, containing at least: a measuring device (2), one or more energy stores (3) and an insulating vessel (6), comprising a top (7), a container wall (8) and a base (9). The handling of the transport containers (1) is improved in practice by the top (7) and the base (9) each having at least one thermally insulating component (10) and by the container wall (8) being designed as a high-vacuum superinsulator (13).

The invention relates to a transport system for the long-term transport of preferably biological material, where the temperature of the material to be transported must not be outside a predefined temperature range during the entire transport, irrespective of the respective ambient temperature, and also to a transport container, preferably capable of being used in the aforementioned transport system.

In particular in connection with recent developments in the area of biotechnology, medicine and pharmacology, so-called long-term transport, that is to say transport with a transport time of more than 100 hours, is increasingly necessary. In the process, all the usual transport means, such as automobile, rail and aircraft are used, different transport regulations having to be complied with in international transport.

The prior art shows different solutions for the implementation of an extremely wide range of transport tasks in connection with the transport of biological material. In these known solutions, the maintenance of a constant temperature (DE 695 12 750 T2) is in particular taken into account. In the event of greater temperature fluctuations during the transport of the biological material, in particular in the case of long-term transport over large distances, such as in the case of intercontinental transport with an aircraft, the maintenance of a constant temperature regularly cannot be ensured. In addition, if this undesired temperature change occurs during the transport, this is regularly established only at the destination. In many cases, this material is then unusable by the user, and a new supply of material is imperative. The initiation of new transport of new material has the effect of an additional loss of time, which can lead to considerable process disruption for the user.

To a large extent [sic] from DE 296 06 303 U1 is a container for the transport of temperature-sensitive goods, for example samples of biological/genetic goods, having a thermally insulating box-like container which has thermal insulation in the base and in the top, contains a load space and an incorporated and controllable, electrically operated cooling unit. This conventional, electrically operated cooling unit continually maintains the desired temperature in the interior of the container. In order to maintain the desired temperature, this cooling unit thus has to be carried along together with the transport container during the transport, which entails considerable costs and is not possible in every case, for example in the case of air transport.

The invention is based on the object of providing a transport system and a transport container of the type specified in the preambles of claims 1 and 6, it being possible to dispense with an electrically operated cooling unit during the transport, the aforementioned disadvantages being avoided and, in particular with a simple construction, improved and more secure transport being made possible.

The object is achieved by means of the features of claim 1 and 6, respectively.

As a result of the achievement of the object according to the invention, it becomes possible, depending on the material to be transported and the desired range of the transport temperature, to provide a respectively optimized transport system and a transport container which is suitable in this regard. The transport system according to the invention permits continuous monitoring of the transport of the transport container itself and checking of the temperature variation in the respective storage space by means of the chosen data transmission and evaluation of the data from the measuring device.

By means of the inventive combination of a plurality of measures and components for insulation, known per se, it is surprisingly possible to achieve a very high degree of temperature stability in the interior of the insulating vessel. In this case, the invention applies technologies which permit the transport container to be produced in a technologically simple and therefore cost-effective manner. The very high temperature stability in the interior of the hermetically closed transport vessel, achieved in accordance with the invention, permits the use of the energetically beneficial energy store which, in the sense of the invention, may be both a heat and a cold store.

A transport container in the sense of the invention is also a container primarily suitable for the storage of materials, that is to say a transport and/or storage container.

Preferred refinements and developments of the teaching of the invention according to claim 1 form the subject of subclaims 2 to 5.

A particularly advantageous development of the invention provides for at least one electronic acquisition and evaluation unit to be required for the transport system. This unit functions as a central unit for all the data input by means of data transmission. It acquires and assesses the data, but can also process the latter, store it or pass it on. Electronic acquisition and evaluation units in the sense of the invention are data processing systems, computers, microprocessors and the like, including the usual software. In this case, one data memory, which then receives data from all the transport containers, can be adequate for a plurality of transport containers, for example all the transport containers in one goods delivery. Alternatively, a data memory can be assigned to each transport container.

The communication between a measuring device and an electronic data memory, but also the unit for temperature measurement and all the other electronic units of the transport system is carried out in a manner known from the prior art, in a wire-free or wire-bound manner.

A measuring device in the sense of the invention comprises both conventional temperature measuring devices, which are in direct contact with the medium to be measured, and also non-contact measuring devices. In this case, in order to measure the temperature, all the temperature-dependent properties of the substances, such as thermal expansion, change in the electrical resistance, formation of a thermoelectric voltage and the like, can be used as the measuring principle. In device terms, a measuring device corresponding to the teaching of the invention comprises all known temperature measuring devices which are known to those skilled in the art. These can be both simple devices, such as a thermometer, but also completely autonomous electronic temperature measuring devices. These measuring devices regularly have, as integral constituent parts, at least one unit for temperature measurement. Such a unit for temperature measurement is, for example, sensors of an extremely wide range of designs, which normally transmit their measured data in a wire-free or wire-bound manner to the central unit of the measuring device.

Further advantageous developments of the invention according to claim 6 are specified in the subclaims 7 to 20.

In a preferred embodiment, the container wall of the insulating vessel is designed as a tubular high-vacuum superinsulator, the double-walled tube system being composed of stainless steel.

The energy store used in the transport container can also be a sensory or a chemical energy store. The choice of the respective energy store is expediently made on the basis of the material to be transported and the desired range of fluctuation of the transport temperature.

### In the following text, the invention will be explained further with the explanation of three preferred exemplary embodiments, using the drawing, and also in general terms. In the drawing:

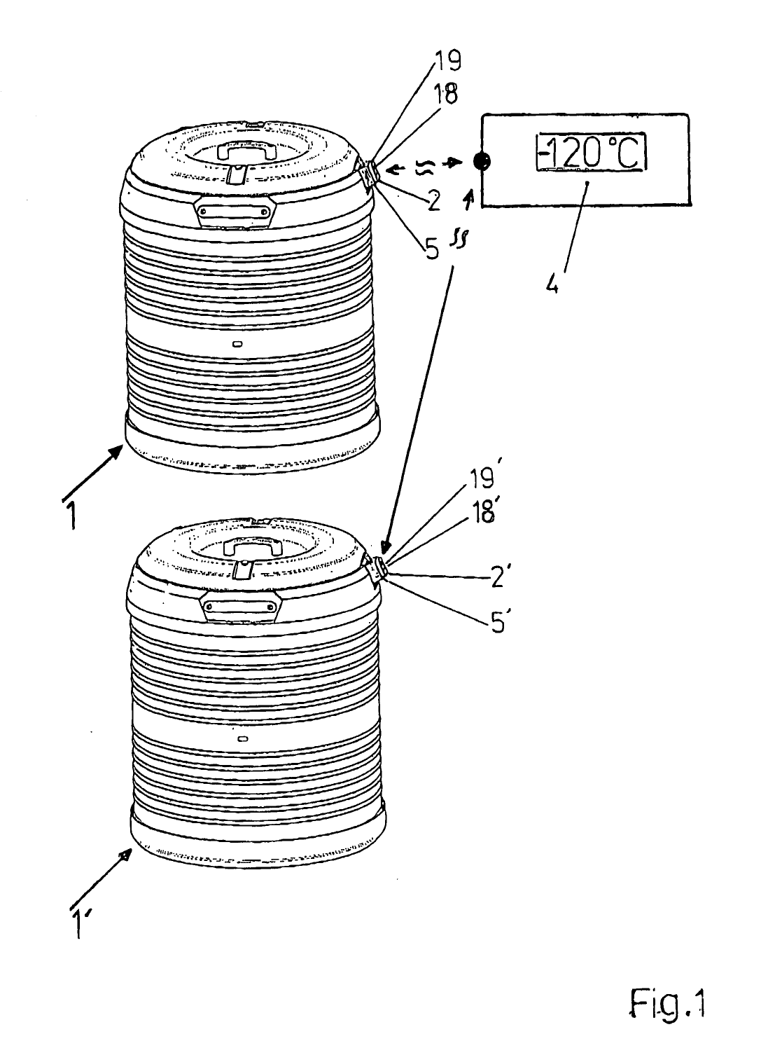

FIG. 1 shows a schematically very simplified basic illustration of the transport system,

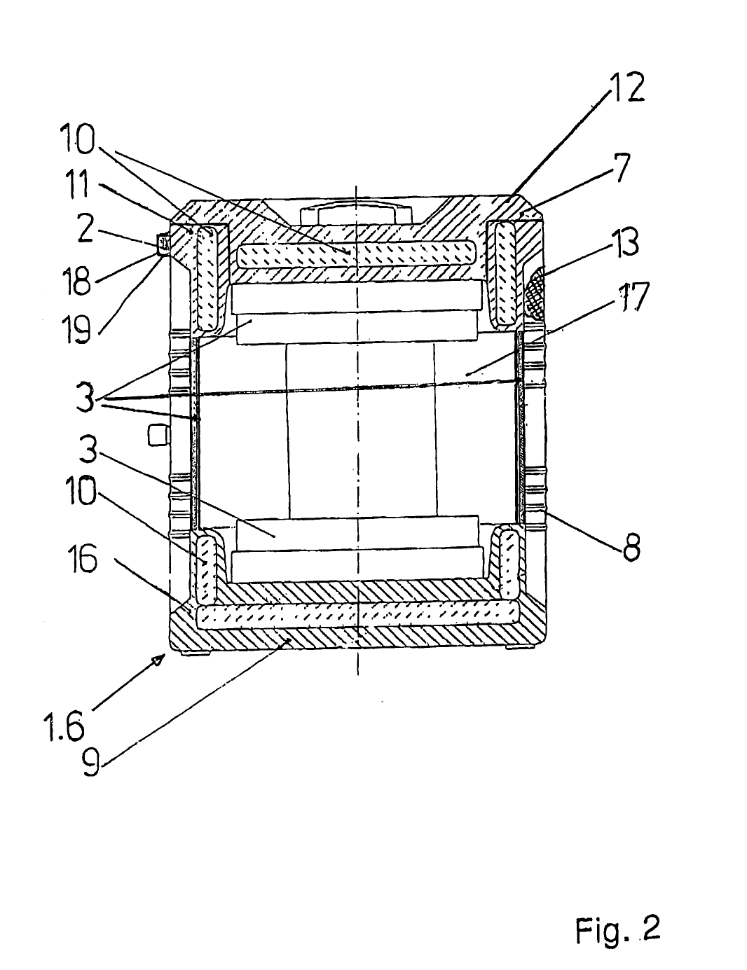

FIG. 2 shows a sectional drawing of a transport container,

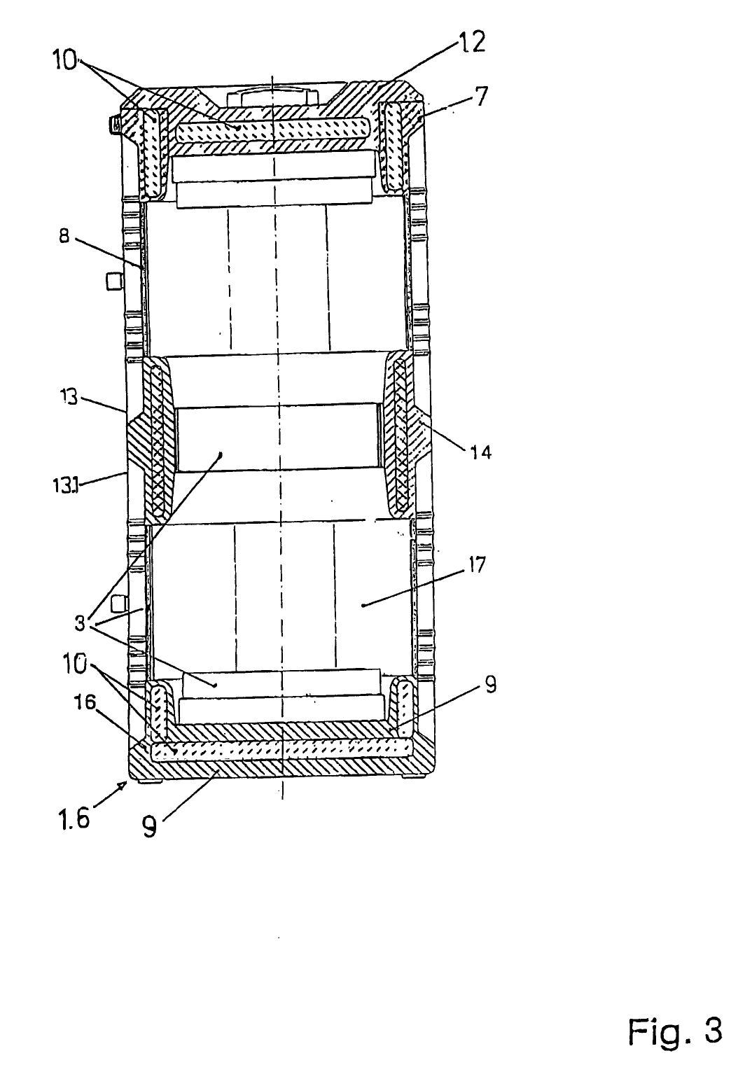

FIG. 3 shows a sectional drawing of a transport container having a container wall comprising two high-vacuum superinsulators.

In the very simplified illustration of FIG. 1, an embodiment of a transport system is illustrated as an example. This contains two transport containers 1, 1′, but does not count as restrictive, so any other number of transport containers is also practicable. The transport containers 1, 1′ in this embodiment are in each case fully functioning system components, in particular they are each equipped with a data memory 5. Furthermore, their basic components specifically include a measuring device 2, a thermal energy store 3 and an insulating vessel 6. Also shown schematically as a block 4 is an acquisition and evaluation unit. This acquisition and evaluation unit 4 is an external unit in FIG. 1, that is to say in this embodiment it is not fitted to one of the transport containers 1, 1. This unit comprises all the components required for its operation and therefore constitutes a completely autonomous functional unit. Advantageously, depending on the respective embodiment, all or a plurality of the components, in particular electronic components, of the transport container and of the acquisition and evaluation unit 4 are implemented in compact functional units. On the basis of the exemplary embodiment according to FIG. 1, the following can be integrated in a functional unit: the measuring device 2, the data memory 5, including the transmitter, data interfaces, the data display 18 and an electric energy store 19, which is used to supply power to the electric components. These components communicate with one another in the usual way.

The measured data from the measuring device 2, 2′, which in this design passes to the data memory 5, 5′ in a wire-bound form, is transmitted to the acquisition and evaluation unit 4 in a wire-free manner. Wire-free data transmission in the sense of the invention comprises all technical solutions known in this regard, for example including technical configurations for data transmission over relatively great distances, such as radio links, which regularly require transmitters and receivers. This wire-free data transmission makes it possible, for example within the context of transatlantic transport, to obtain information about the temperature variation in the transport containers 1, 1′ continuously by means of the acquisition and evaluation unit 4. Furthermore, additional information, such as the respective location of the transport containers 1, 1′, can be obtained.

Irrespective of the manner of the data transmission, the measured data in the acquisition and evaluation unit 4 is available in particular in digital form, so that this data can be further processed, forwarded or output in the usual way. Transport logs or certificates can easily be compiled.

The wire-free data transmission is represented in FIG. 1 by the waves W.

FIG. 2 reveals a transport container 1 in a schematic sectional illustration. The insulating vessel 5 of the transport container 1, which stands upright and whose outer contour is cylindrical, is composed of a base 9, a container wall 8 and a top 7, which are firmly connected to one another. The top 7 comprises an insulating ring 11 and a lid 12. The lid 12 hermetically closes the opening in the insulating ring 11, through which the interior of the insulating vessel 5 can be reached from outside. The lid 12 has a closure device, not illustrated in FIG. 2, which is conventional for the application and which permits repeated hermetic closure. The opening is dimensioned to be as small as possible, in particular to avoid thermal energy losses, but nevertheless sufficiently large that the transported goods and the energy store 3 can pass into and out of the interior without problems. Integrated in the insulating ring 11 is the measuring device 2 which, in its specific configuration, is a temperature measuring device. In addition to the measuring device 2, the following are integrated in a compact, shock-resistant design in a functional unit: the data memory 5, including a transmitter, a data interface, the data display 18 and an electric energy store 19. The components of this functional unit are linked with one another and communicate with one another. The data memory 5 stores in particular the measured values from the temperature measuring device. The data from the data memory 5 can be transmitted both in a wire-free manner, then continuously, periodically, repeatedly or once, to an external acquisition and evaluation unit 4, not shown in FIG. 2, by radio. In addition, there is the possibility at the destination or at check points during the transport to read out the data via a data interface, if necessary by using a transportable intermediate store, and/or of transmitting said data to an acquisition and evaluation unit 4. The data display 18 is designed as a permanent temperature display in the exemplary embodiment. The electric energy store 19 can be a battery or a rechargeable accumulator.

The very good insulation of the insulating vessel 6 is achieved by the use of a high-vacuum superinsulator 13, having a thermal transmission value of about 0.1 mW/mK, a film vacuum insulation (about 4 mW/mK) and thermally insulating materials, such as foamed insulation (about 30 mW/mK).

The high-vacuum superinsulator 13 which, in the exemplary embodiment, is used as the container wall 8, comprises a double-walled tube system composed of stainless steel. This tube system is closed in a vacuum-tight manner, for example by welding. The tube system may be produced very simply, including a container base compared with known cryoinsulating containers which are designed in one piece. In addition, in the case of this tube system, enhanced implosion security is provided, and better handling of the transport container 1 overall is possible as a result of the weight reduction achieved. Additional beads in the outer tube, as indicated in FIG. 2, permit a further reduction in the wall thickness and ensure resilient equalization between the inner and outer tube. In order to reduce thermal energy losses at the tube ends, the inner wall can be of tapered design.

In the exemplary embodiment, the insulating component 10 used is a foil vacuum insulation, such as the product NANOGEL™ from Cabot Corporation, US, integrated in the base insulating ring 16, in the lid 12 and in the insulating ring 11 and, in principle, also in the connecting element 14, not shown in FIG. 2. The foil vacuum insulation is completely enclosed in a vacuum-tight manner within an insulating mass of material, here foamed in foamed material in annular form in the insulating ring 11, in plate form in the lid 12 and in annular form and plate form in the base insulating ring 16. By foaming in the foil superinsulation, the mechanical strength of the respective component and of the insulating vessel 6 as a whole is increased, a reduction in the wall thickness is possible and increased mechanical projection is provided.

The base insulating ring 16 and the container wall 8, and also the container wall 8 and the insulating ring 11 are permanently connected to one another by means of an insulating material, here a foamed material with edge reinforcement.

In the interior of the insulating vessel 6, a plurality of energy stores 3 enclose the cylindrical storage space 17, preferably virtually completely in this case, three or four identically shaped energy stores form a hollow cylinder, which has two openings toward the lid 12 and the base insulating ring 16, respectively. This hollow cylinder rests with its outer wall on the container wall 8 and on the base insulating ring 16 and insulating ring 15.

Two cylindrical energy stores 3 engage in the two, preferably equally sized, openings of the hollow cylinder.

In FIG. 3, a transport container 1 whose container wall 8 comprises two high-vacuum superinsulators 13, 13.1 is illustrated in a schematic sectional illustration. The two high-vacuum superinsulators 13, 13.1 are permanently connected to each other by means of a connecting element 14. In this embodiment, the two energy stores 3 which bound the storage space 17 between base 7 and lid 12 in this regard are arranged one above the other.

In principle, the overall height of the insulating vessel 6 can be enlarged by means of the use of a plurality of high-vacuum superinsulators 13, 13.1, 13.n, use preferably being made of high-vacuum superinsulators 13 of a predetermined length (on the modular principle, as it is known). In this case, the connection between the high-vacuum superinsulators 13, 13.1, 13.n is achieved by means of one or more connecting elements 14.

1. A transport system for the long-term transport of preferably biological material, containing at least: one or more transport containers (1), each of which has a measuring device (2), an insulating vessel (6), comprising a top (7), a container wall (8) and a base (9), and at least one energy store (3), it being possible for the data from the respective measuring device (2) to be stored in a data memory (5) and for a data transmission of data from the data memory (5) to at least one acquisition and evaluation unit (4) to be implemented continuously, periodically, repeatedly or once, and the insulating vessel (6) having at least one thermally insulating component (10) in each case in the top (7) and in the base (9), characterized in that the energy store (3) is a latent energy store and the container wall (8) is designed as a high-vacuum superinsulator (13).

2. The transport system as claimed in claim 1, characterized by at least one electronic acquisition and evaluation unit (4) and also at least one electronic data memory (5) for one or more transport containers (1).

3. The transport system as claimed in claims 1 and 2, characterized in that in each case a measuring device (2) communicates with an electronic data memory (5) in a wire-free or wire-bound manner, it being possible for its data to be transmitted to an acquisition and evaluation unit (4) in a wire-free or wire-bound manner.

4. The transport system as claimed in one of claims 1 to 3, characterized in that the respective measuring device (2) has at least one unit for temperature measurement.

5. The transport system as claimed in one of claims 1 to 4, characterized in that in a transport vessel (1), at least on the basis of the material to be transported and the desired range of the transport temperature, an energy store (3) that is optimized in this respect can be used.

6. A transport container, preferably for a transport system as claimed in one of claims 1 to 5, containing at least:
a measuring device (2), one or more energy stores (3) and an insulating vessel (6), comprising a top (7), a container wall (8) and a base (9), and the top (7) and the base (9) at least in each case having a thermally insulating component (10), characterized
in that the energy store (3) is a latent energy store and
in that the container wall (8) is designed as a high-vacuum superinsulator (13).

7. The transport container as claimed in claim 6, characterized in that the top (7) comprises in particular an insulating ring (11), which is permanently connected to the container wall (8), and a lid (12), the insulating ring (11) having an opening which can be closed hermetically by means of at least part of the lid (12).

8. The transport container as claimed in claim 7, characterized in that the container wall (8) comprises a plurality of tubular high-vacuum superinsulators (13), in each case a connecting element (14) being arranged between the high-vacuum superinsulators (13).

9. The transport container as claimed in one of claims 6 to 8, characterized in that the connecting element (14) is permanently connected to the high-vacuum superinsulators (13) and has at least one thermally insulating component (10).

10. The transport container as claimed in claim 9, characterized in that the connecting element (14), the top (7) and the base (9) are composed in particular of foamed insulating material with edge reinforcement.

11. The transport container as claimed in one of claims 7 to 10, characterized in that the container wall (8) of the tubular high-vacuum superinsulator (13) comprises a double-walled tube system composed of stainless steel.

12. The transport container as claimed in claim 11, characterized in that the container inner wall (15) tapers at its ends.

13. The transport container as claimed in one of claims 6 to 12, characterized in that the base (9) in particular comprises an insulating ring (11) which is permanently connected to the container wall (8).

14. The transport container as claimed in one of claims 6 to 13, characterized in that the thermally insulating component (10) is a foil vacuum insulation.

15. The transport container as claimed in one of claims 6 to 14, characterized in that the foil vacuum insulation is arranged in an annular and/or plate-like manner within the top (7), there in the insulating ring (11) and in the lid (12), in the base (9) and/or in the connecting piece (14), and is enclosed completely by thermally insulating materials.

16. The transport container as claimed in claim 15, characterized in that the insulating ring (11), the lid (12), the base (9) and/or the connecting piece (14) are composed of a foil vacuum insulation.

17. The transport container as claimed in one of claims 6 to 16, characterized in that the energy store (3) is a sensory or a chemical energy store.

18. The transport container as claimed in claim 17, characterized in that a plurality of energy stores (3) are arranged within the insulating vessel (6) in such a way that these enclose the storage space (17), preferably completely.

19. The transport container as claimed in one of claims 6 to 18, characterized in that the measuring device (2) is preferably of compact design and comprises a data memory (5), a data display (18), an electric, rechargeable energy store (19) and at least one unit for temperature measurement.

20. The transport container as claimed in claim 9, characterized in that the measuring device (2) has a data interface for data transmission to an external acquisition and evaluation unit (4).
